(19) United States
(12) Patent Application Publication
(10) Pub. No.: US 2013/0286196 A1
(43) Pub. Date: Oct. 31, 2013

(54) LASER LINE PROBE THAT PRODUCES A LINE OF LIGHT HAVING A SUBSTANTIALLY EVEN INTENSITY DISTRIBUTION

(71) Applicant: FARO TECHNOLOGIES, INC., Lake Mary, FL (US)

(72) Inventor: Paul C. Atwell, Lake Mary, FL (US)

(73) Assignee: FARO TECHNOLOGIES, INC., Lake Mary, FL (US)

(21) Appl. No.: 13/739,280

(22) Filed: Jan. 11, 2013

Related U.S. Application Data
(63) Continuation-in-part of application No. 13/721,169, filed on Dec. 20, 2012.
(60) Provisional application No. 61/580,817, filed on Dec. 28, 2011.

(51) Int. Cl. G01C 11/02

(52) U.S. Cl. CPC G01C 11/02
USPC 348/136

(57) ABSTRACT

A laser line probe (LLP) configured to measure an object is provided. The LLP includes a projector, a camera, a bracket, and an electronic circuit. The projector includes a light source, a first lens system and a continuously varying neutral density filter. The projector is configured for generating a line of light having a substantially even intensity distribution and for projecting the line of light onto the object. The camera includes a second lens system and a photosensitive array. The second lens system is configured to collect the light reflected by or scattered off the object as a first collected light and to image the first collected light onto the photosensitive array. The electronic circuit includes a processor and is configured to determine three-dimensional coordinates of a plurality of points of light projected on the object by the projector.

### CROSS REFERENCE TO RELATED APPLICATIONS

The present application claims the benefit of U.S. patent application Ser. No. 13/721,169, filed Dec. 20, 2012, the contents of which are hereby incorporated by reference in its entirety.

### BACKGROUND

The present disclosure relates generally to a laser line probe (LLP), and more particularly to a LLP that produces a line of light having a substantially even intensity distribution, which may be used for example, in conjunction with a portable articulated arm coordinate measuring machine (AACMM) or in a fixed (i.e., non-movable) inspection installation (e.g., an automobile assembly line).

Portable AACMMs have found widespread use in the manufacturing or production of parts where there is a need to rapidly and accurately verify the dimensions of the part during various stages of the manufacturing or production (e.g., machining) of the part. Portable AACMMs represent a vast improvement over known stationary or fixed, cost-intensive and relatively difficult to use measurement installations, particularly in the amount of time it takes to perform dimensional measurements of relatively complex parts. Typically, a user of a portable AACMM simply guides a probe along the surface of the part or object to be measured. The measurement data are then recorded and provided to the user. In some cases, the data are provided to the user in visual form, for example, three-dimensional (3D) form on a computer screen. In other cases, the data are provided to the user in numeric form, for example when measuring the diameter of a hole, the text “Diameter=1.0034” is displayed on a computer screen.

An example of a prior art portable articulated arm CMM is disclosed in commonly assigned U.S. Pat. No. 5,402,582 ('582), which is incorporated herein by reference in its entirety. The '582 patent discloses a 3-D measuring system comprised of a manually-operated articulated arm CMM having a support base on one end and a measurement probe at the other end. Commonly assigned U.S. Pat. No. 5,611,147 ('147), which is incorporated herein by reference in its entirety, discloses a similar articulated arm CMM. In the '147 patent, the articulated arm CMM includes a number of features including an additional rotational axis at the probe end, thereby providing for an arm with either a two-two-two or a two-two-three axis configuration (the latter case being a seven axis arm). Commonly assigned U.S. Patent Publication No. 2011/0119026 ('026), which is incorporated herein by reference in its entirety, discloses a laser line scanner, also known as a LLP, attached to a manually-operated articulated arm CMM, the LLP capable of collecting 3D information about the surface of an object without making direct contact with the object.

It is known to attach various accessory devices to a CMM. For example, it is known to attach a LLP to a CMM. An LLP typically projects a laser line that is substantially straight to obtain 3D features of an object without the line scanner having a probe that must come into physical contact with the object to take measurements. The method or means of attachment and the attachment point of the LLP to the CMM can vary. However, it is common to attach the LLP in the vicinity of the probe end of the CMM, for example, near a fixed “hard” probe that may be used to contact the object and measure points. Generally, the LLP acquires many more data points of the object being measured than the hard probe.

It is also common for the LLP to utilize a coherent light source, such as a laser, in conjunction with a type of lens, such as a rod lens, to focus the projected straight line of light onto the object being measured. This light is reflected or scattered off the object and acquired by a camera spaced some distance away from the projector. Cameras used by contemporary LLPs typically cannot handle the extremely high contrasts caused by a high laser light exposure and thus, a lower exposure setting is often used by the LLPs. However, the use of a lower exposure setting often causes other problems that include, for example, degradation in signal-to-noise ratio for the case in which the intensity of a line of light projected by the LLP is non-uniform. Such a non-uniform intensity may, for example, have points closer to the center of the line having a higher intensity than points closer to the ends of the line. This non-uniformity and decay at the ends of the line may result in less accurate measurement of three-dimensional points with an LLP. Consequently, there may be an increase in the error of the 3D coordinate values measured by the LLP when a line of light projected by an LLP onto an object is not uniform.

While existing CMMs and LLPs are suitable for their intended purposes, what is needed is a LLP that has certain features of embodiments of the present invention.

### SUMMARY OF THE INVENTION

In accordance with an embodiment of the present invention, a laser line probe (LLP) configured to measure an object includes a projector that includes a light source configured to emit light, a first lens system, and a continuously varying neutral density filter. The first lens system is configured to receive the light and to spread out the light into a first line of light having a first intensity distribution across the first line of light. The continuously varying neutral density filter is configured to convert the first line of light into a second line of light having a substantially uniform intensity distribution across the second line of light, and to project the second line of light onto the object. The LLP also includes a camera that includes a second lens system and a photosensitive array. The camera has predetermined characteristics that include a focal length of the second lens system and a position of the photosensitive array relative to the second lens system. The second lens system is configured to collect the light reflected by or scattered off the object as a first collected light and to image the first collected light onto the photosensitive array. The photosensitive array is configured to convert the first collected light into an electrical signal. The LLP further includes a bracket to which are attached in a substantially fixed and predetermined geometrical configuration the projector and the camera. The LLP further includes an electronic circuit, including a processor, where the electronic circuit is configured to determine three-dimensional (3D) coordinates of a plurality of points of light projected on the object by the projector. The 3D coordinates are based at least in part on the electrical signal, the camera characteristics, and the geometrical configuration.

In accordance with another embodiment of the present invention, a portable articulated arm coordinate measuring machine (AACMM) for measuring the coordinates of an object in space includes a manually positionable articulated arm having opposed first and second ends, the arm portion including a plurality of connected arm segments, each arm segment including at least one position transducer for producing a position signal. The AACMM also includes a base section connected to the second end, and a probe assembly connected to the first end, the probe assembly including a LLP that scans the object in space. The LLP includes a projector that includes a first lens system and a continuously varying neutral density filter configured to receive light from the first lens system and project it onto the object. The continuously varying neutral density filter is configured to project light having an intensity distribution that is substantially uniform along the length of the line. The AACMM also includes a camera with a second lens system and a photosensitive array. The camera has predetermined characteristics that include a focal length of the lens system and a position of the photosensitive array relative to the lens system. The second lens system is configured to collect the light reflected by or scattered off the object as a first collected light and to image the first collected light onto the photosensitive array. The photosensitive array is configured to convert the first collected light into an electrical signal. The AACMM further includes a bracket to which are attached in a substantially fixed and predetermined geometrical configuration the projector and the camera, and an electronic circuit that includes a processor. The electronic circuit is configured to determine 3D coordinates of a plurality of points of light projected on the object by the projector. The 3D coordinates are based at least in part on the electrical signal, the camera characteristics, and the geometrical configuration.

In accordance with a further embodiment of the present invention, a method of operating a LLP for measuring an object in space includes emitting light from a light source, receiving the light at a first lens system and spreading out the light, by the first lens system, into a first line of light having a first intensity distribution across the first line of light. The first line of light is converted, by a continuously varying neutral density filter, into a second line of light having a substantially uniform intensity distribution across the second line of light. The second line of light is projected onto the object. A camera collects the light reflected by or scattered off the object as a first collected light onto a photosensitive array. The camera includes a second lens system and the photosensitive array, and the camera has predetermined characteristics including a focal length of the second lens system and a position of the photosensitive array relative to the second lens system. The laser light source, the first lens system, the filter and the camera are attached to a bracket in a substantially fixed and predetermined geometrical configuration. The first collected light is converted by the photosensitive array into an electrical signal. 3D coordinates of a plurality of points of light projected on the object by the projector are determined by a processor based at least in part on the electrical signal, the camera characteristics and the geometrical configuration.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several FIGURES:

FIG. 1, including FIGS. 1A and 1B, are perspective views of a portable articulated arm coordinate measuring machine (AACMM) having embodiments of various aspects of the present invention therewithin;

FIG. 2, including FIGS. 2A-2D taken together, is a block diagram of electronics utilized as part of the AACMM of FIG. 1 in accordance with an embodiment;

FIG. 3, including FIGS. 3A and 3B taken together, is a block diagram describing detailed features of the electronic data processing system of FIG. 2 in accordance with an embodiment;

FIG. 4 is an isometric view of the probe end of the AACMM of FIG. 1;

FIG. 5 is a side view of the probe end of FIG. 4 with the handle being coupled thereto;

FIG. 6 is a partial side view of the probe end of FIG. 4 with the handle attached;

FIG. 7 is an enlarged partial side view of the interface portion of the probe end of FIG. 6;

FIG. 8 is another enlarged partial side view of the interface portion of the probe end of FIG. 5;

FIG. 9 is an isometric view partially in section of the handle of FIG. 4;

FIG. 10 is an isometric view of the probe end of the AACMM of FIG. 1 with a laser line probe (LLP) device attached;

FIG. 11 is an isometric view partially in section of the LLP of FIG. 10;

FIG. 12 is a schematic diagram of a projection portion of the LLP of FIG. 11 in accordance with an embodiment of the present invention; and

FIG. 13 is a schematic diagram illustrating how the LLP of FIG. 11 determines distance from the LLP to an object in accordance with an embodiment of the present invention.

### DETAILED DESCRIPTION

An embodiment of the present invention provides an enhanced laser line probe (LLP) that produces a line of light having a substantially even intensity distribution across the length of the line. The line of light produced by the LLP is projected onto an object and used by the LLP to measure the object. An embodiment utilizes a projector that includes a lens and a continuously varying neutral density filter. The lens scatters light from a light source into a substantially straight line having an uneven intensity distribution, and the continuously varying neutral density filter evens out the intensity distribution of the line prior to the line being projected onto the object. Thus, the line projected onto the object no longer exhibits a hot spot (i.e., high intensity) near the center of the line's length with reduced intensity towards the end points of the line as is typical when the line is generated using, for example, a lens such as a cylindrical lens such or a rod lens. Because the line no longer fades at the end points, additional and more accurate measurement points along the line may be collected by the LLP. Typically, the end points of the line are not sharply defined, but instead are generally defined by those points where the line falls off to a predetermined level of intensity (e.g., 2% or 50%).

Portable articulated arm coordinate measuring machines (“AACMM”) are used in a variety of applications to obtain measurements of objects. Embodiments of the present invention provide advantages in allowing an operator to utilize an AACMM with a LLP scanner attached thereto, wherein the LLP scanner utilizes a continuously varying neutral density filter to achieve improvements over prior art LLP scanners that produce laser lines of uneven intensity. However, embodiments of the present invention are not limited for use with portable AACMMS. Instead, LLP scanners in accordance with embodiments of the present invention may be utilized as part of, or in conjunction with many other types of devices, such as non-articulated arm CMMs, and in fixed inspection installations such as at various fixed points along an automobile assembly line.

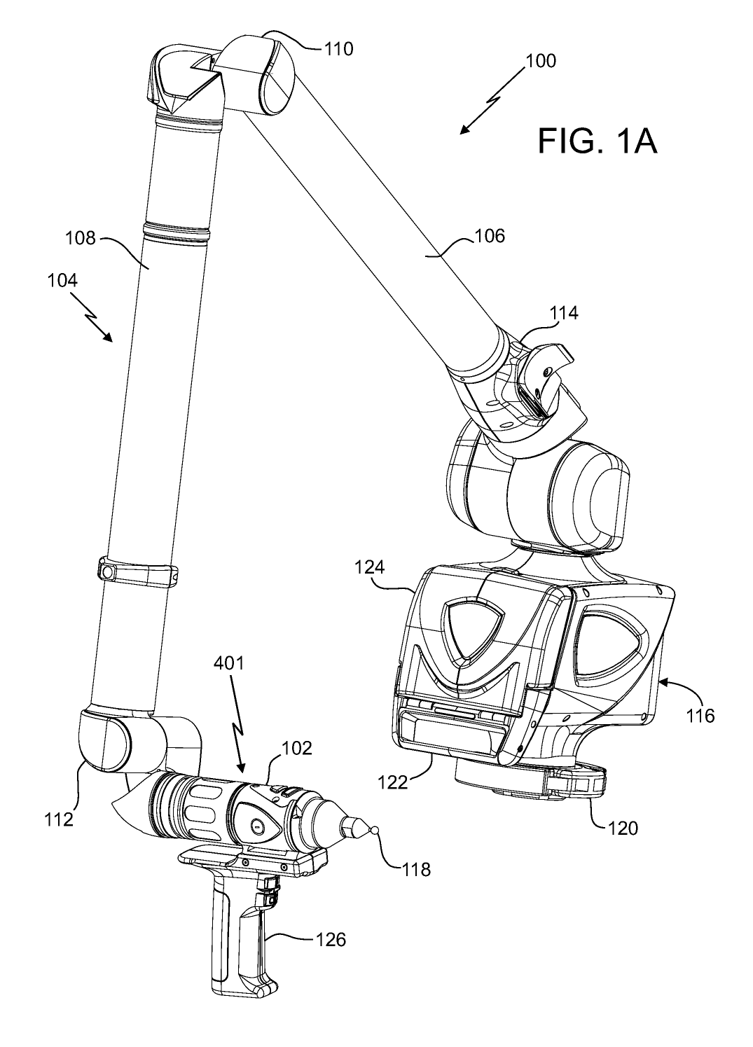

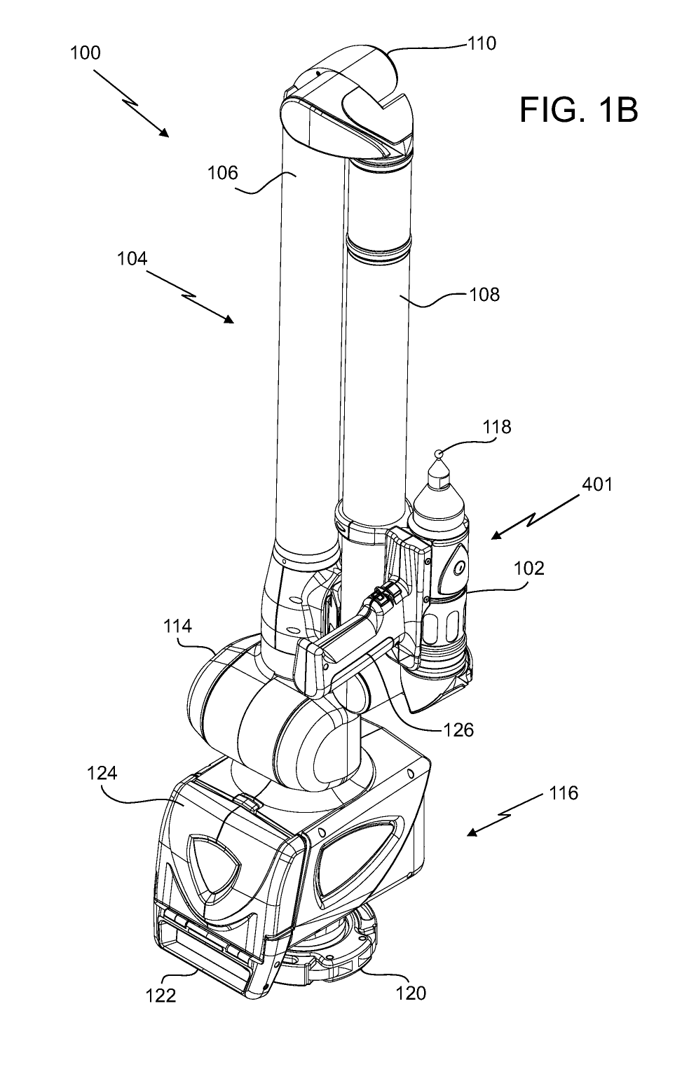

FIGS. 1A and 1B illustrate, in perspective, an AACMM 100 according to various embodiments of the present invention, an articulated arm being one type of coordinate measuring machine. As shown in FIGS. 1A and 1B, the exemplary AACMM 100 may comprise a six or seven axis articulated measurement device having a probe end 401 that includes a measurement probe housing 102 coupled to an arm portion 104 of the AACMM 100 at one end. The arm portion 104 comprises a first arm segment 106 coupled to a second arm segment 108 by a first grouping of bearing cartridges 110 (e.g., two bearing cartridges). A second grouping of bearing cartridges 112 (e.g., two bearing cartridges) couples the second arm segment 108 to the measurement probe housing 102. A third grouping of bearing cartridges 114 (e.g., three bearing cartridges) couples the first arm segment 106 to a base 116 located at the other end of the arm portion 104 of the AACMM 100. Each grouping of bearing cartridges 110, 112, 114, provides for multiple axes of articulated movement. Also, the probe end 401 may include a measurement probe housing 102 that comprises the shaft of the seventh axis portion of the AACMM 100 (e.g., a cartridge containing an encoder system that determines movement of the measurement device, for example a probe 118, in the seventh axis of the AACMM 100). In this embodiment, the probe end 401 may rotate about an axis extending through the center of measurement probe housing 102. In use of the AACMM 100, the base 116 is typically affixed to a work surface.

Each bearing cartridge within each bearing cartridge grouping 110, 112, 114, typically contains an encoder system (e.g., an optical angular encoder system). The encoder system (i.e., transducer) provides an indication of the position of the respective arm segments 106, 108 and corresponding bearing cartridge groupings 110, 112, 114, that all together provide an indication of the position of the probe 118 with respect to the base 116 (and, thus, the position of the object being measured by the AACMM 100 in a certain frame of reference—for example a local or global frame of reference). The arm segments 106, 108 may be made from a suitably rigid material such as but not limited to a carbon composite material for example. A portable AACMM 100 with six or seven axes of articulated movement (i.e., degrees of freedom) provides advantages in allowing the operator to position the probe 118 in a desired location within a 360° area about the base 116 while providing an arm portion 104 that may be easily handled by the operator. However, it should be appreciated that the illustration of an arm portion 104 having two arm segments 106, 108 is for exemplary purposes, and the claimed invention should not be so limited. An AACMM 100 may have any number of arm segments coupled together by bearing cartridges (and, thus, more or less than six or seven axes of articulated movement or degrees of freedom).

The probe 118 is detachably mounted to the measurement probe housing 102, which is connected to bearing cartridge grouping 112. A handle 126 is removable with respect to the measurement probe housing 102 by way of, for example, a quick-connect interface. The handle 126 may be replaced with another device (e.g., a LLP in accordance with embodiments of the present invention, as described in detail hereinafter), thereby providing advantages in allowing the operator to use different measurement devices with the same AACMM 100. In exemplary embodiments, the probe housing 102 houses a removable probe 118, which is a contacting measurement device and may have different probe tips 118 that physically contact the object to be measured, including, but not limited to: ball, touch-sensitive, curved and extension type probes. In other embodiments, the measurement is performed, for example, by a non-contacting device such as the aforementioned laser line probe (LLP). In certain embodiments of the present invention, the handle 126 is replaced with the LLP using the quick-connect interface.

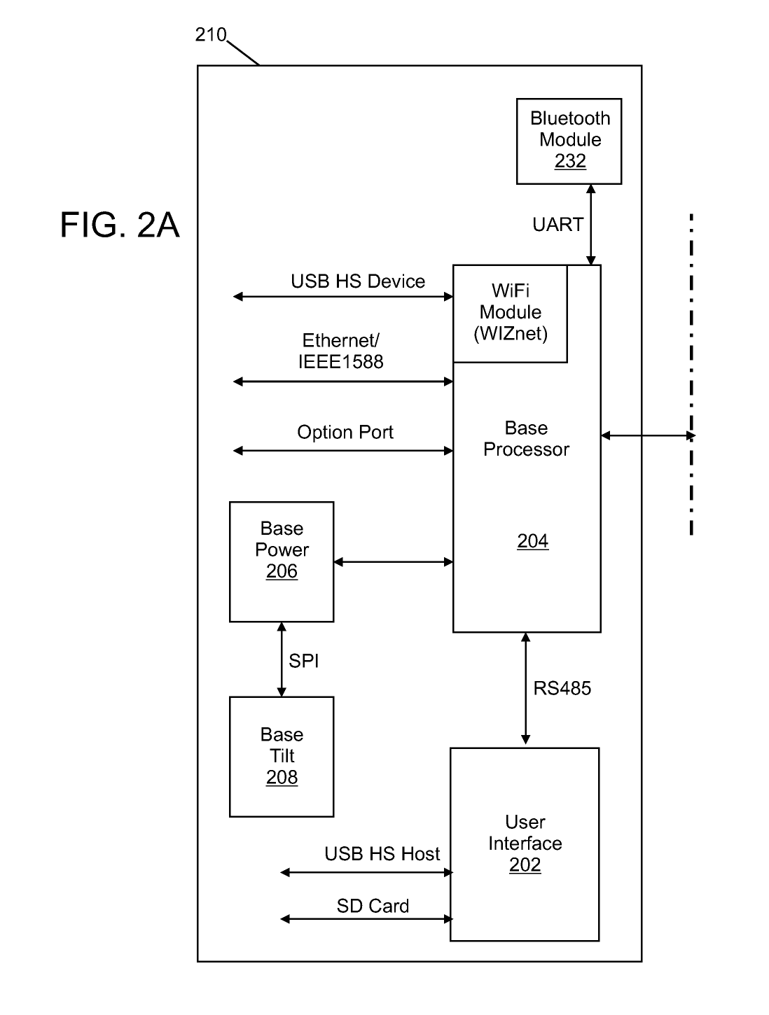

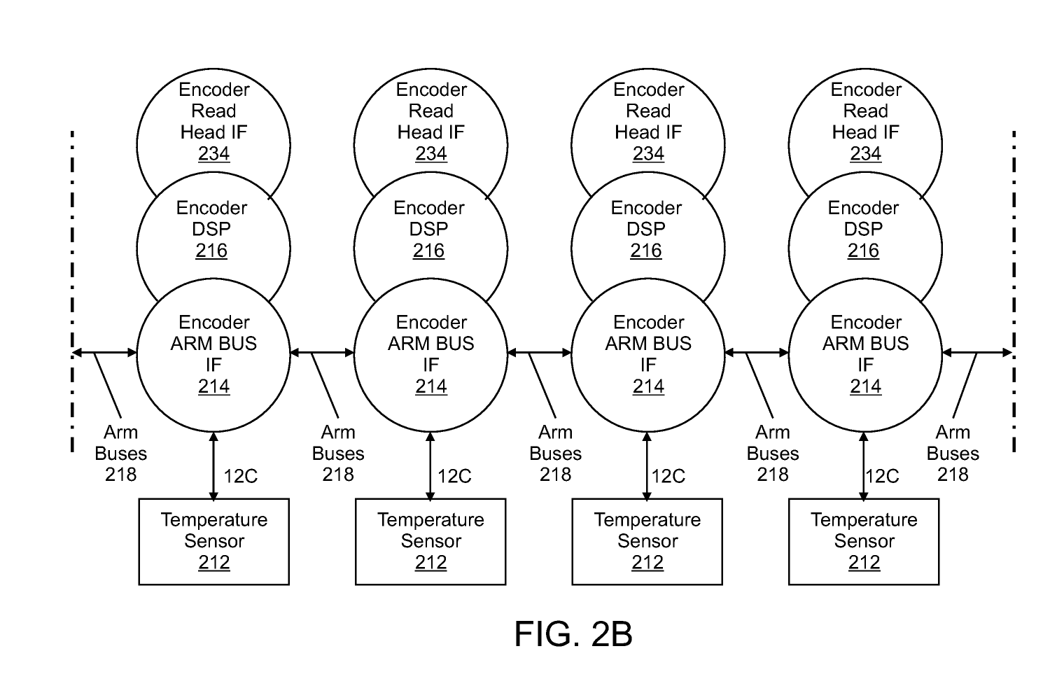

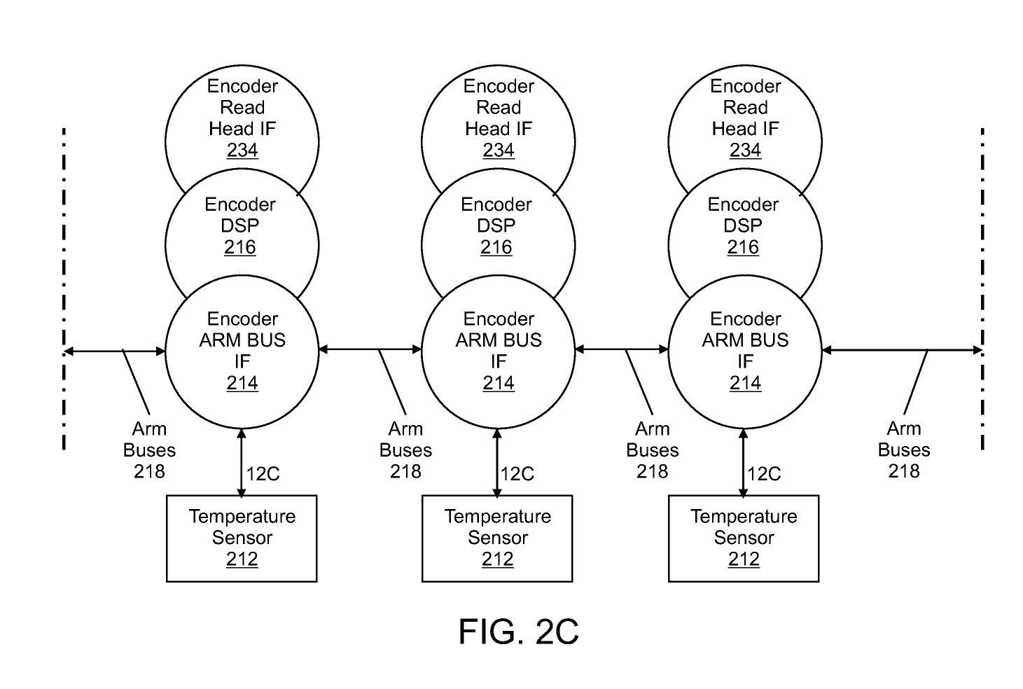

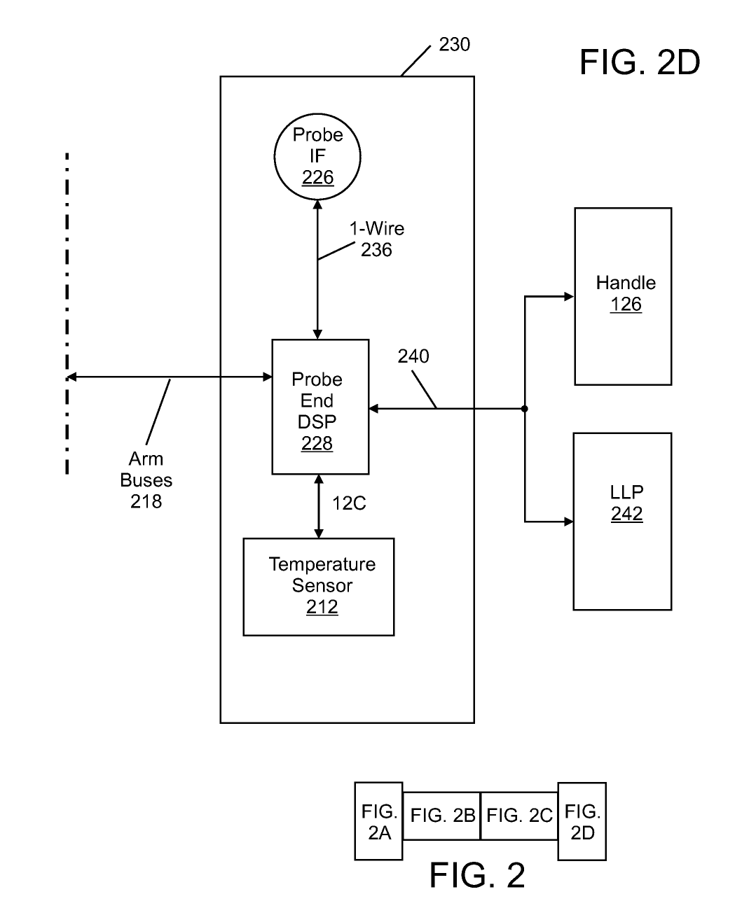

As shown in FIGS. 1A and 1B, the AACMM 100 includes the removable handle 126 that provides advantages in allowing accessories or functionality to be changed without removing the measurement probe housing 102 from the bearing cartridge grouping 112. As discussed in more detail below with respect to FIG. 2, the removable handle 126 may also include an electrical connector that allows electrical power and data to be exchanged with the handle 126 and the corresponding electronics located in the probe end 401.

In various embodiments, each grouping of bearing cartridges 110, 112, 114, allows the arm portion 104 of the AACMM 100 to move about multiple axes of rotation. As mentioned, each bearing cartridge grouping 110, 112, 114, includes corresponding encoder systems, such as optical angular encoders for example, that are each arranged coaxially with the corresponding axis of rotation of, e.g., the arm segments 106, 108. The optical encoder system detects rotational (swivel) or transverse (hinge) movement of, e.g., each one of the arm segments 106, 108 about the corresponding axis and transmits a signal to an electronic data processing system within the AACMM 100 as described in more detail herein below. Each individual raw encoder count is sent separately to the electronic data processing system as a signal where it is further processed into measurement data. No position calculator separate from the AACMM 100 itself (e.g., a serial box) is required, as disclosed in commonly assigned U.S. Pat. No. 5,402,582 ('582).

The base 116 may include an attachment device or mounting device 120. The mounting device 120 allows the AACMM 100 to be removably mounted to a desired location, such as an inspection table, a machining center, a wall or the floor for example. In one embodiment, the base 116 includes a handle portion 122 that provides a convenient location for the operator to hold the base 116 as the AACMM 100 is being moved. In one embodiment, the base 116 further includes a movable cover portion 124 that folds down to reveal a user interface, such as a display screen.

In accordance with an embodiment, the base 116 of the portable AACMM 100 contains or houses an electronic data processing system that includes two primary components: a base processing system that processes the data from the various encoder systems within the AACMM 100 as well as data representing other arm parameters to support three-dimensional (3D) positional calculations; and a user interface processing system that includes an on-board operating system, a touch screen display, and resident application software that allows for relatively complete metrology functions to be implemented within the AACMM 100 without the need for connection to an external computer.

The electronic data processing system in the base 116 may communicate with the encoder systems, sensors, and other peripheral hardware located away from the base 116 (e.g., a LLP that is mounted on the AACMM 100 in place of the removable handle 126, as described in detail hereinafter). The electronics that support these peripheral hardware devices or features may be located in each of the bearing cartridge groupings 110, 112, 114, located within the portable AACMM 100.

FIG. 2 is a block diagram of electronics utilized in an AACMM 100 in accordance with an embodiment. The embodiment shown in FIG. 2 includes an electronic data processing system 210 including a base processor board 204 for implementing the base processing system, a user interface board 202, a base power board 206 for providing power, a Bluetooth module 232, and a base tilt module 208. The user interface board 202 includes a computer processor for executing application software to perform user interface, display, and other functions described herein.

As shown in FIG. 2, the electronic data processing system 210 is in communication with the aforementioned plurality of encoder systems via one or more arm buses 218. In the embodiment depicted in FIG. 2, each encoder system generates encoder data and includes: an encoder arm bus interface 214, an encoder digital signal processor (DSP) 216, an encoder read head interface 234, and a temperature sensor 212. Other devices, such as strain sensors, may be attached to the arm bus 218.

Also shown in FIG. 2 are probe end electronics 230 that are in communication with the arm bus 218. The probe end electronics 230 include a probe end DSP 228, a temperature sensor 212, a handle/LLP interface bus 240 that connects with the handle 126, the LLP 242 via the quick-connect interface in an embodiment, and a probe interface 226. The quick-connect interface allows access by the handle 126 to the data bus, control lines, and power bus used by the LLP 242 and other accessories. In an embodiment, the probe end electronics 230 are located in the measurement probe housing 102 on the AACMM 100. In an embodiment, the handle 126 may be removed from the quick-connect interface and measurement may be performed by the LLP 242 communicating with the probe end electronics 230 of the AACMM 100 via the handle/LLP interface bus 240. In an embodiment, the electronic data processing system 210 is located in the base 116 of the AACMM 100, the probe end electronics 230 are located in the measurement probe housing 102 of the AACMM 100, and the encoder systems are located in the bearing cartridge groupings 110, 112, 114. The probe interface 226 may connect with the probe end DSP 228 by any suitable communications protocol, including commercially-available products from Maxim Integrated Products, Inc. that embody the 1-wire® communications protocol 236.

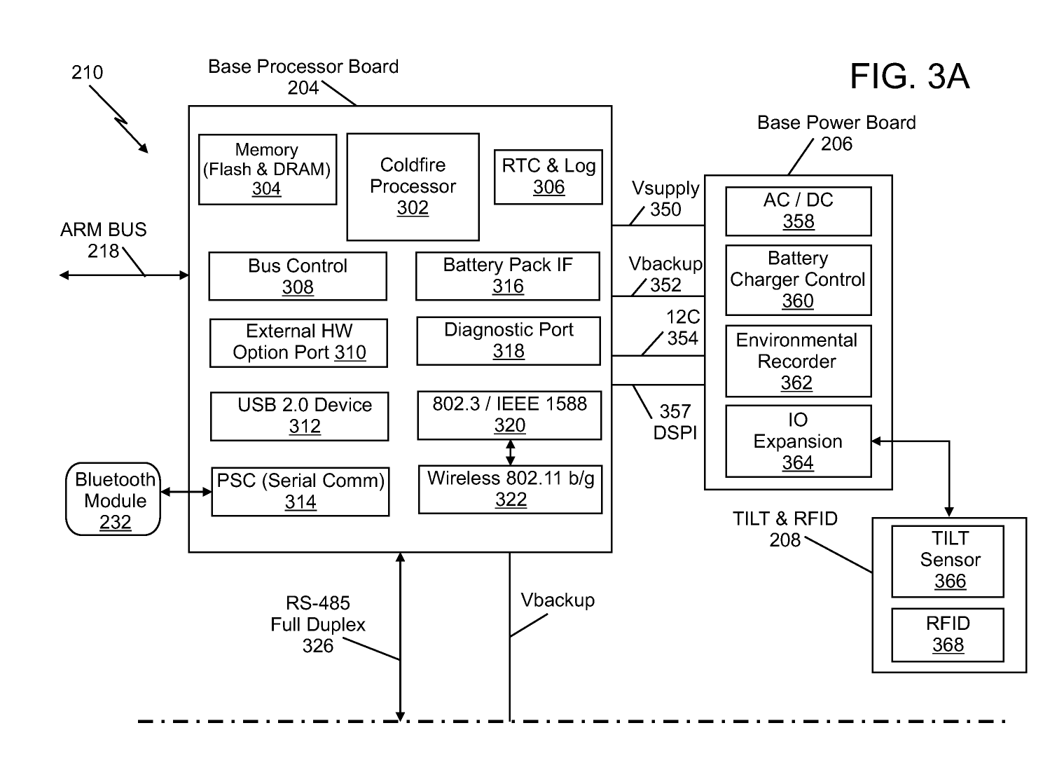

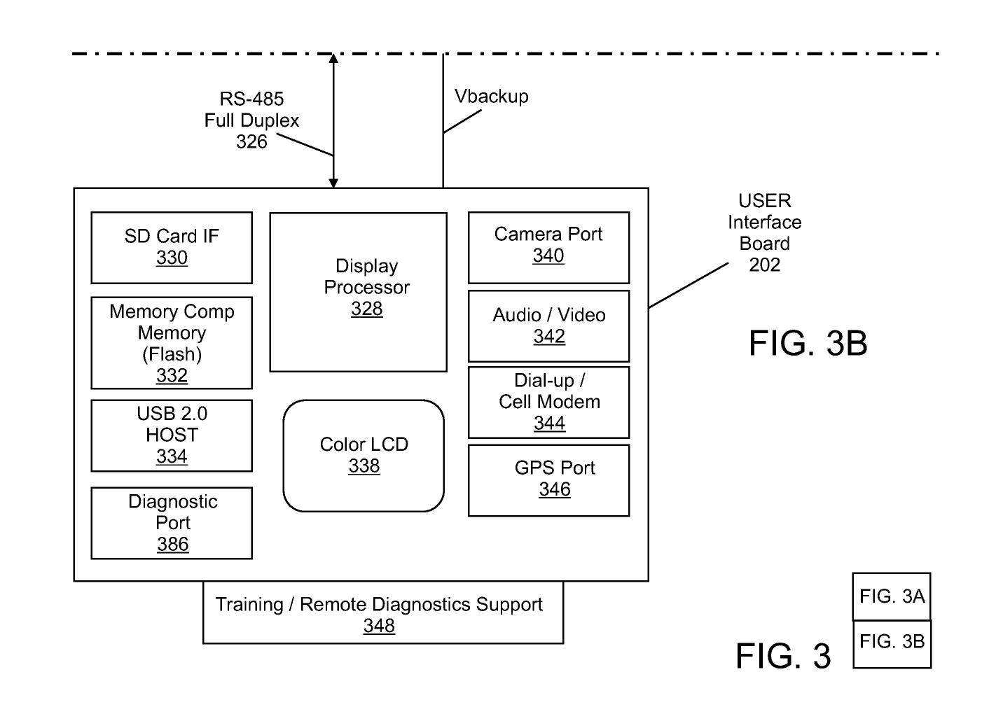

FIG. 3 is a block diagram describing detailed features of the electronic data processing system 210 of the AACMM 100 in accordance with an embodiment. In an embodiment, the electronic data processing system 210 is located in the base 116 of the AACMM 100 and includes the base processor board 204, the user interface board 202, a base power board 206, a Bluetooth module 232, and a base tilt module 208.

In an embodiment shown in FIG. 3, the base processor board 204 includes the various functional blocks illustrated therein. For example, a base processor function 302 is utilized to support the collection of measurement data from the AACMM 100 and receives raw arm data (e.g., encoder system data) via the arm bus 218 and a bus control module function 308. The memory function 304 stores programs and static arm configuration data. The base processor board 204 also includes an external hardware option port function 310 for communicating with any external hardware devices or accessories such as an LLP 242. A real time clock (RTC) and log 306, a battery pack interface (IF) 316, and a diagnostic port 318 are also included in the functionality in an embodiment of the base processor board 204 depicted in FIG. 3.

The base processor board 204 also manages all the wired and wireless data communication with external (host computer) and internal (display processor 202) devices. The base processor board 204 has the capability of communicating with an Ethernet network via an Ethernet function 320 (e.g., using a clock synchronization standard such as Institute of Electrical and Electronics Engineers (IEEE) 1588), with a wireless local area network (WLAN) via a LAN function 322, and with Bluetooth module 232 via a parallel to serial communications (PSC) function 314. The base processor board 204 also includes a connection to a universal serial bus (USB) device 312.

The base processor board 204 transmits and collects raw measurement data (e.g., encoder system counts, temperature readings) for processing into measurement data without the need for any preprocessing, such as disclosed in the serial box of the aforementioned '582 patent. The base processor board 204 sends the processed data to the display processor 328 on the user interface board 202 via an RS485 interface (IF) 326. In an embodiment, the base processor board 204 also sends the raw measurement data to an external computer.

Turning now to the user interface board 202 in FIG. 3, the angle and positional data received by the base processor is utilized by applications executing on the display processor 328 to provide an autonomous metrology system within the AACMM 100. Applications may be executed on the display processor 328 to support functions such as, but not limited to: measurement of features, guidance and training graphics, remote diagnostics, temperature corrections, control of various operational features, connection to various networks, and display of measured objects. Along with the display processor 328 and a liquid crystal display (LCD) 338 (e.g., a touch screen LCD) user interface, the user interface board 202 includes several interface options including a secure digital (SD) card interface 330, a memory 332, a USB Host interface 334, a diagnostic port 336, a camera port 340, an audio/video interface 342, a dial-up/cell modem 344 and a global positioning system (GPS) port 346.

The electronic data processing system 210 shown in FIG. 3 also includes a base power board 206 with an environmental recorder 362 for recording environmental data. The base power board 206 also provides power to the electronic data processing system 210 using an AC/DC converter 358 and a battery charger control 360. The base power board 206 communicates with the base processor board 204 using inter-integrated circuit (I2C) serial single ended bus 354 as well as via a DMA serial peripheral interface (DSPI) 356. The base power board 206 is connected to a tilt sensor and radio frequency identification (RFID) module 208 via an input/output (I/O) expansion function 364 implemented in the base power board 206.

Though shown as separate components, in other embodiments all or a subset of the components may be physically located in different locations and/or functions combined in different manners than that shown in FIG. 3. For example, in one embodiment, the base processor board 204 and the user interface board 202 are combined into one physical board.

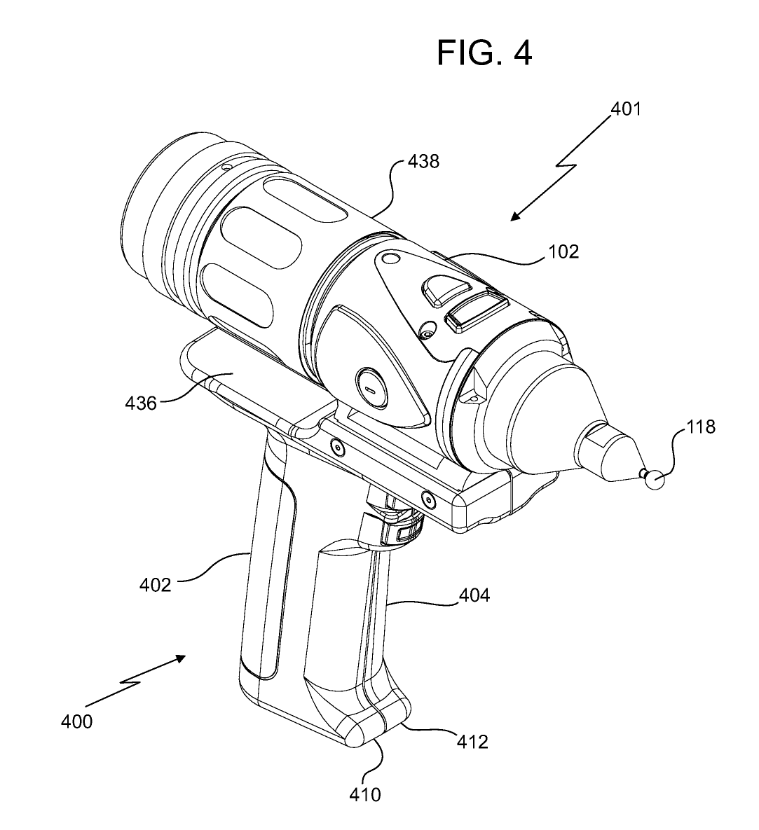

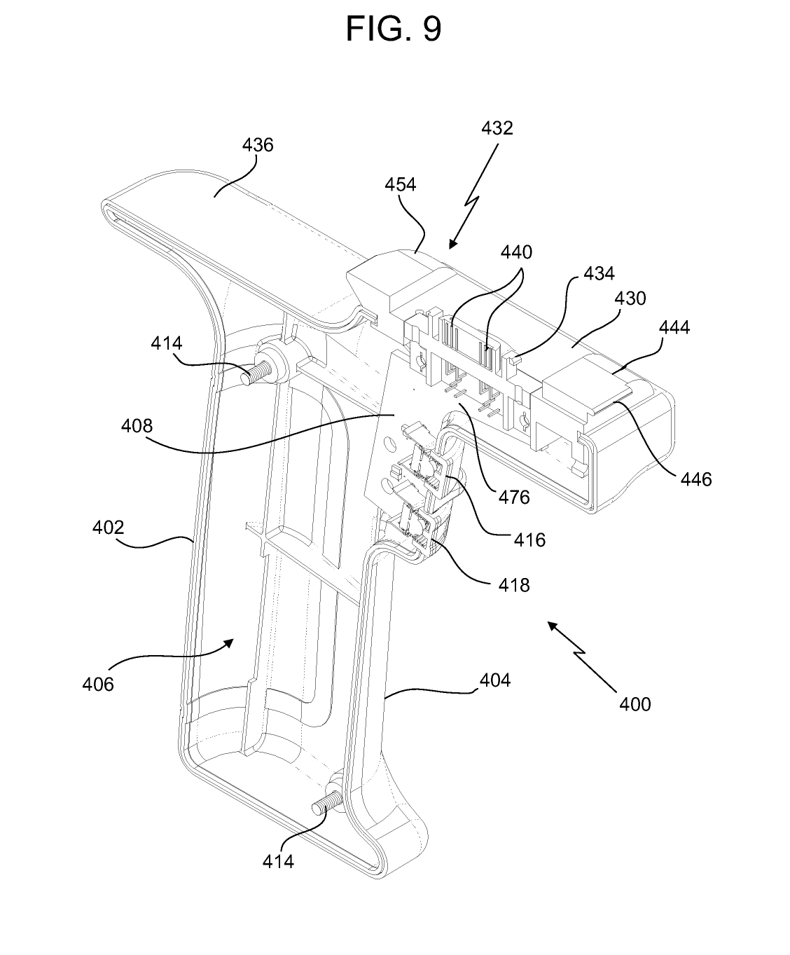

Referring now to FIGS. 4-9, an exemplary embodiment of a probe end 401 is illustrated having a measurement probe housing 102 with a quick-connect mechanical and electrical interface that allows removable and interchangeable device 400 to couple with AACMM 100. In the exemplary embodiment, the device 400 includes an enclosure 402 that includes a handle portion 404 that is sized and shaped to be held in an operator's hand, such as in a pistol grip for example. The enclosure 402 is a thin wall structure having a cavity 406 (FIG. 9). The cavity 406 is sized and configured to receive a controller 408. The controller 408 may be a digital circuit, having a microprocessor for example, or an analog circuit. In one embodiment, the controller 408 is in asynchronous bidirectional communication with the electronic data processing system 210 (FIGS. 2 and 3). The communication connection between the controller 408 and the electronic data processing system 210 may be wired (e.g. via controller 420) or may be a direct or indirect wireless connection (e.g. Bluetooth or IEEE 802.11) or a combination of wired and wireless connections. In the exemplary embodiment, the enclosure 402 is formed in two halves 410, 412, such as from an injection molded plastic material for example. The halves 410, 412 may be secured together by fasteners, such as screws 414 for example. In other embodiments, the enclosure halves 410, 412 may be secured together by adhesives or ultrasonic welding for example.

The handle portion 404 also includes buttons or actuators 416, 418 that may be manually activated by the operator. The actuators 416, 418 are coupled to the controller 408 that transmits a signal to a controller 420 within the probe housing 102. In the exemplary embodiments, the actuators 416, 418 perform the functions of actuators 422, 424 located on the probe housing 102 opposite the device 400. It should be appreciated that the device 400 may have additional switches, buttons or other actuators that may also be used to control the device 400, the AACMM 100 or vice versa. Also, the device 400 may include indicators, such as light emitting diodes (LEDs), sound generators, meters, displays or gauges for example. In one embodiment, the device 400 may include a digital voice recorder that allows for synchronization of verbal comments with a measured point. In yet another embodiment, the device 400 includes a microphone that allows the operator to transmit voice activated commands to the electronic data processing system 210.

In one embodiment, the handle portion 404 may be configured to be used with either operator hand or for a particular hand (e.g. left handed or right handed). The handle portion 404 may also be configured to facilitate operators with disabilities (e.g. operators with missing fingers or operators with prosthetic arms). Further, the handle portion 404 may be removed and the probe housing 102 used by itself when clearance space is limited. As discussed above, the probe end 401 may also comprise the shaft of the seventh axis of AACMM 100. In this embodiment the device 400 may be arranged to rotate about the AACMM seventh axis.

The probe end 401 includes a mechanical and electrical interface 426 having a first connector 429 (FIG. 8) on the device 400 that cooperates with a second connector 428 on the probe housing 102. The connectors 428, 429 may include electrical and mechanical features that allow for coupling of the device 400 to the probe housing 102. In one embodiment, the interface 426 includes a first surface 430 having a mechanical coupler 432 and an electrical connector 434 thereon. The enclosure 402 also includes a second surface 436 positioned adjacent to and offset from the first surface 430. In the exemplary embodiment, the second surface 436 is a planar surface offset a distance of approximately 0.5 inches from the first surface 430. As will be discussed in more detail below, this offset provides a clearance for the operator's fingers when tightening or loosening a fastener such as collar 438. The interface 426 provides for a relatively quick and secure electronic connection between the device 400 and the probe housing 102 without the need to align connector pins, and without the need for separate cables or connectors.

The electrical connector 434 extends from the first surface 430 and includes one or more connector pins 440 that are electrically coupled in asynchronous bidirectional communication with the electronic data processing system 210 (FIGS. 2 and 3), such as via one or more arm buses 218 for example. The bidirectional communication connection may be wired (e.g. via arm bus 218), wireless (e.g. Bluetooth or IEEE 802.11), or a combination of wired and wireless connections. In one embodiment, the electrical connector 434 is electrically coupled to the controller 420. The controller 420 may be in asynchronous bidirectional communication with the electronic data processing system 210 such as via one or more arm buses 218 for example. The electrical connector 434 is positioned to provide a relatively quick and secure electronic connection with electrical connector 442 on probe housing 102. The electrical connectors 434, 442 connect with each other when the device 400 is attached to the probe housing 102. The electrical connectors 434, 442 may each comprise a metal encased connector housing that provides shielding from electromagnetic interference as well as protecting the connector pins and assisting with pin alignment during the process of attaching the device 400 to the probe housing 102.

The mechanical coupler 432 provides relatively rigid mechanical coupling between the device 400 and the probe housing 102 to support relatively precise applications in which the location of the device 400 on the end of the arm portion 104 of the AACMM 100 preferably does not shift or move. Any such movement may typically cause an undesirable degradation in the accuracy of the measurement result. These desired results are achieved using various structural features of the mechanical attachment configuration portion of the quick connect mechanical and electronic interface of an embodiment of the present invention.

In one embodiment, the mechanical coupler 432 includes a first projection 444 positioned on one end 448 (the leading edge or “front” of the device 400). The first projection 444 may include a keyed, notched or ramped interface that forms a lip 446 that extends from the first projection 444. The lip 446 is sized to be received in a slot 450 defined by a projection 452 extending from the probe housing 102 (FIG. 8). It should be appreciated that the first projection 444 and the slot 450 along with the collar 438 form a coupler arrangement such that when the lip 446 is positioned within the slot 450, the slot 450 may be used to restrict both the longitudinal and lateral movement of the device 400 when attached to the probe housing 102. As will be discussed in more detail below, the rotation of the collar 438 may be used to secure the lip 446 within the slot 450.

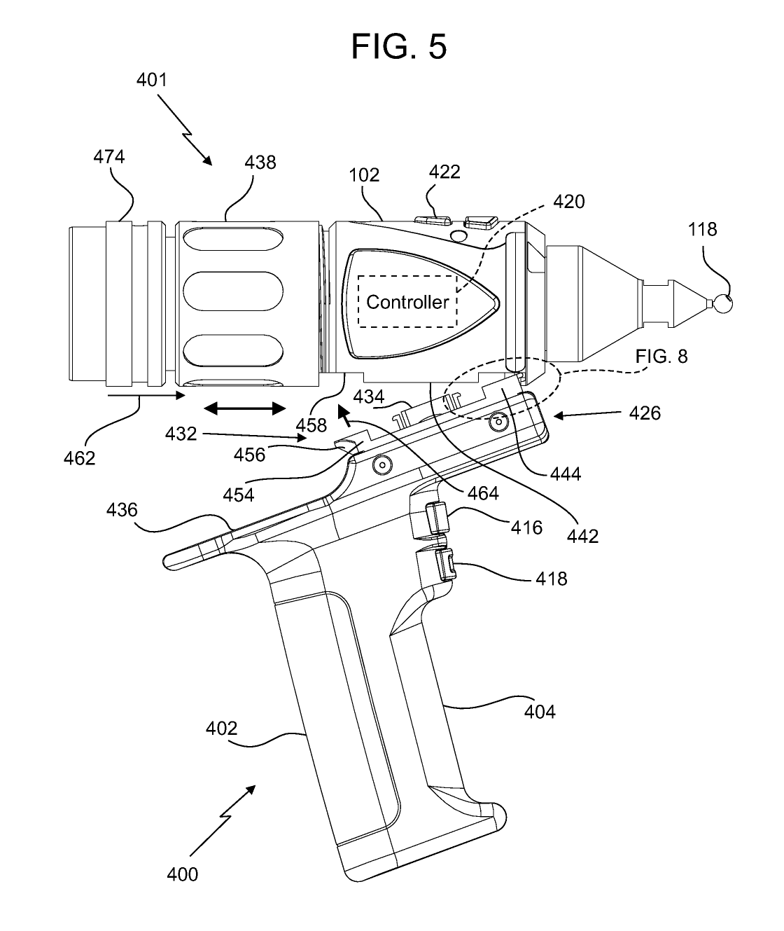

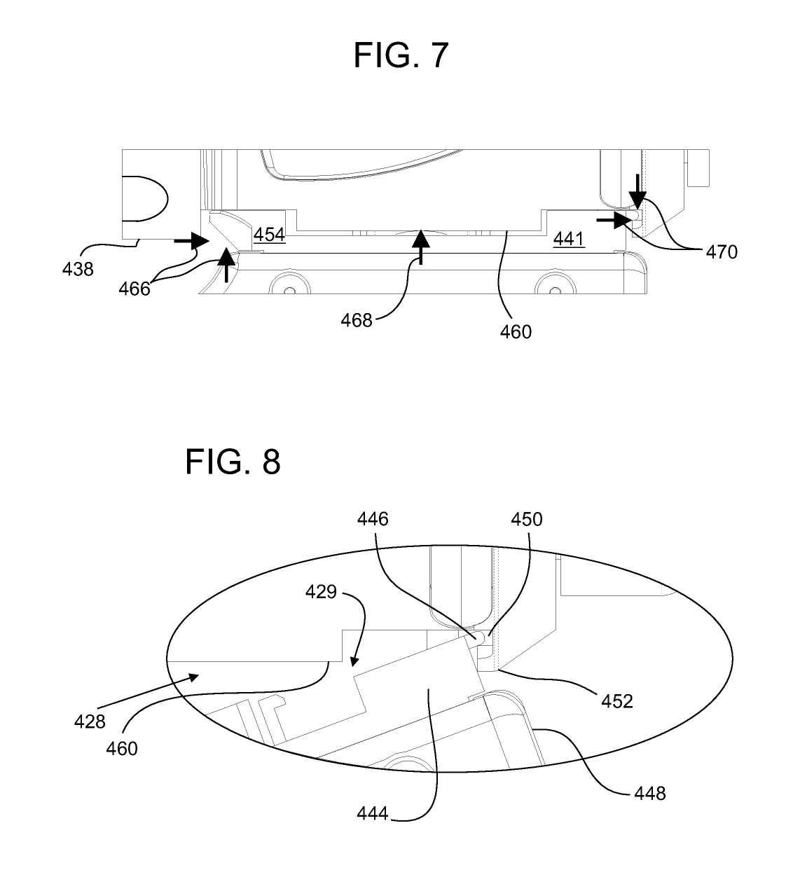

Opposite the first projection 444, the mechanical coupler 432 may include a second projection 454. The second projection 454 may have a keyed, notched-lip or ramped interface surface 456 (FIG. 5). The second projection 454 is positioned to engage a fastener associated with the probe housing 102, such as collar 438 for example. As will be discussed in more detail below, the mechanical coupler 432 includes a raised surface projecting from surface 430 that adjacent to or disposed about the electrical connector 434 which provides a pivot point for the interface 426 (FIGS. 7 and 8). This serves as the third of three points of mechanical contact between the device 400 and the probe housing 102 when the device 400 is attached thereto.

The probe housing 102 includes a collar 438 arranged co-axially on one end. The collar 438 includes a threaded portion that is movable between a first position (FIG. 5) and a second position (FIG. 7). By rotating the collar 438, the collar 438 may be used to secure or remove the device 400 without the need for external tools. Rotation of the collar 438 moves the collar 438 along a relatively coarse, square-threaded cylinder 474. The use of such relatively large size, square-thread and contoured surfaces allows for significant clamping force with minimal rotational torque. The coarse pitch of the threads of the cylinder 474 further allows the collar 438 to be tightened or loosened with minimal rotation.

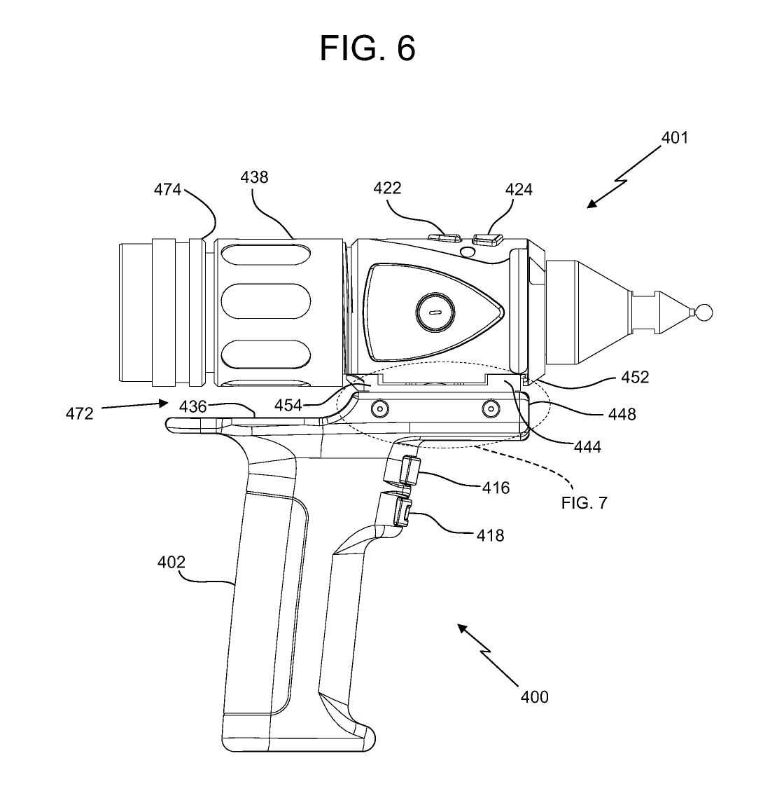

To couple the device 400 to the probe housing 102, the lip 446 is inserted into the slot 450 and the device is pivoted to rotate the second projection 454 toward surface 458 as indicated by arrow 464 (FIG. 5). The collar 438 is rotated causing the collar 438 to move or translate in the direction indicated by arrow 462 into engagement with surface 456. The movement of the collar 438 against the angled surface 456 drives the mechanical coupler 432 against the raised surface 460. This assists in overcoming potential issues with distortion of the interface or foreign objects on the surface of the interface that could interfere with the rigid seating of the device 400 to the probe housing 102. The application of force by the collar 438 on the second projection 454 causes the mechanical coupler 432 to move forward pressing the lip 446 into a seat on the probe housing 102. As the collar 438 continues to be tightened, the second projection 454 is pressed upward toward the probe housing 102 applying pressure on a pivot point. This provides a see-saw type arrangement, applying pressure to the second projection 454, the lip 446 and the center pivot point to reduce or eliminate shifting or rocking of the device 400. The pivot point presses directly against the bottom on the probe housing 102 while the lip 446 is applies a downward force on the end of probe housing 102. FIG. 5 includes arrows 462, 464 to show the direction of movement of the device 400 and the collar 438. FIG. 7 includes arrows 466, 468, 470 to show the direction of applied pressure within the interface 426 when the collar 438 is tightened. It should be appreciated that the offset distance of the surface 436 of device 400 provides a gap 472 between the collar 438 and the surface 436 (FIG. 6). The gap 472 allows the operator to obtain a firmer grip on the collar 438 while reducing the risk of pinching fingers as the collar 438 is rotated. In one embodiment, the probe housing 102 is of sufficient stiffness to reduce or prevent the distortion when the collar 438 is tightened.

Embodiments of the interface 426 allow for the proper alignment of the mechanical coupler 432 and electrical connector 434 and also protect the electronics interface from applied stresses that may otherwise arise due to the clamping action of the collar 438, the lip 446 and the surface 456. This provides advantages in reducing or eliminating stress damage to circuit board 476 mounted electrical connectors 434, 442 that may have soldered terminals. Also, embodiments provide advantages over known approaches in that no tools are required for a user to connect or disconnect the device 400 from the probe housing 102. This allows the operator to manually connect and disconnect the device 400 from the probe housing 102 with relative ease.

Due to the relatively large number of shielded electrical connections possible with the interface 426, a relatively large number of functions may be shared between the AACMM 100 and the device 400. For example, switches, buttons or other actuators located on the AACMM 100 may be used to control the device 400 or vice versa. Further, commands and data may be transmitted from electronic data processing system 210 to the device 400. In one embodiment, the device 400 is a video camera that transmits data of a recorded image to be stored in memory on the base processor 204 or displayed on the display 328. In another embodiment the device 400 is an image projector that receives data from the electronic data processing system 210. In addition, temperature sensors located in either the AACMM 100 or the device 400 may be shared by the other. It should be appreciated that embodiments of the present invention provide advantages in providing a flexible interface that allows a wide variety of accessory devices 400 to be quickly, easily and reliably coupled to the AACMM 100. Further, the capability of sharing functions between the AACMM 100 and the device 400 may allow a reduction in size, power consumption and complexity of the AACMM 100 by eliminating duplicity.

In one embodiment, the controller 408 may alter the operation or functionality of the probe end 401 of the AACMM 100. For example, the controller 408 may alter indicator lights on the probe housing 102 to either emit a different color light, a different intensity of light, or turn on/off at different times when the device 400 is attached versus when the probe housing 102 is used by itself. In one embodiment, the device 400 includes a range finding sensor (not shown) that measures the distance to an object. In this embodiment, the controller 408 may change indicator lights on the probe housing 102 in order to provide an indication to the operator how far away the object is from the probe tip 118. This provides advantages in simplifying the requirements of controller 420 and allows for upgraded or increased functionality through the addition of accessory devices.

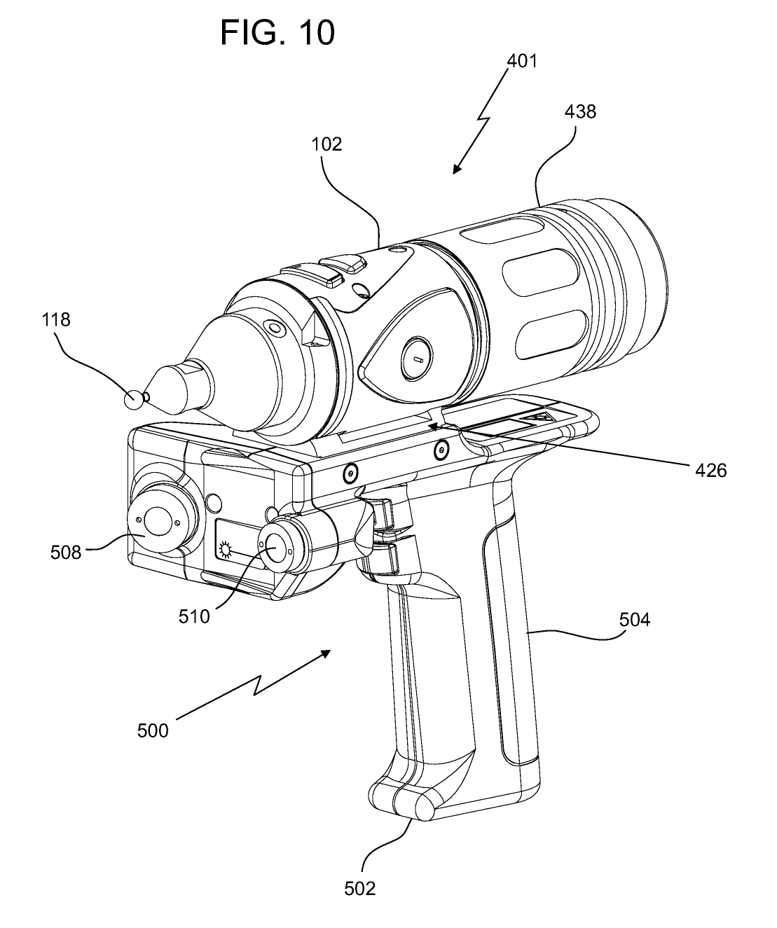

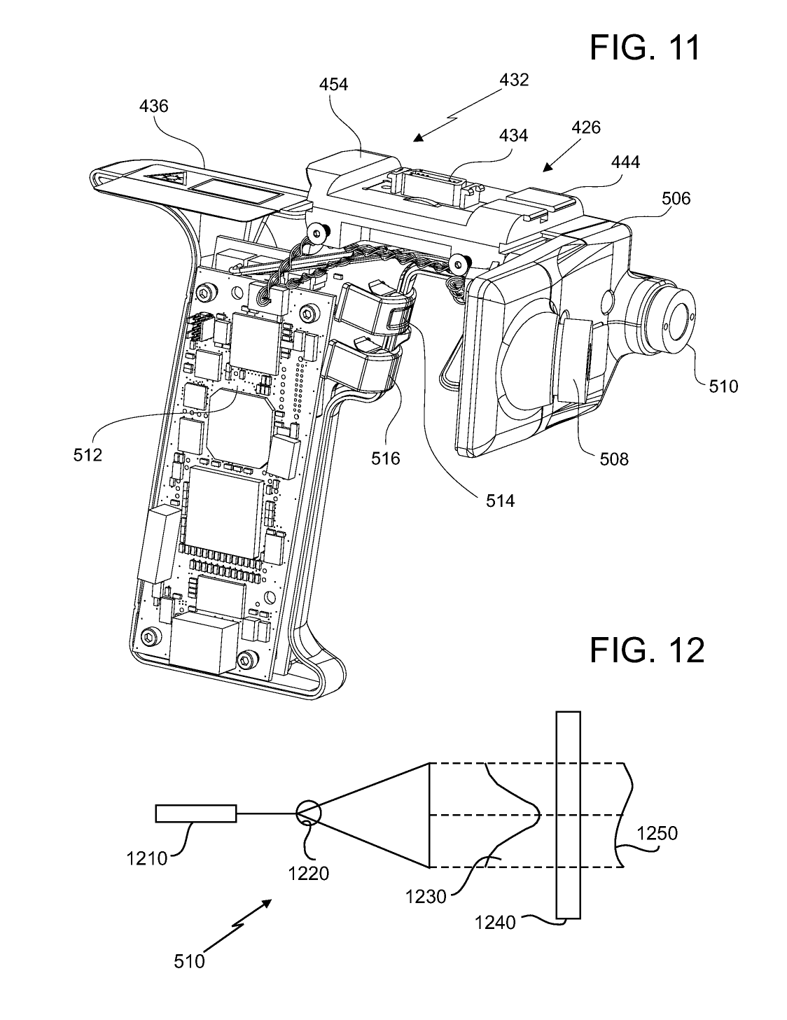

Referring to FIGS. 10-11, embodiments of the present invention provide advantages to camera, signal processing, control and indicator interfaces for a LLP 500 that functions as an accessory device for the AACMM 100. In an embodiment, the LLP utilizes a laser light source that typically has a coherence length of anywhere from a millimeter to hundreds of meters, depending on the type of laser.

The LLP 500 includes an enclosure 502 with a handle portion 504. The LLP 500 further includes an interface 426 on one end that mechanically and electrically couples the LLP 500 to the probe housing 102 as described herein above. The interface 426 allows the LLP 500 to be coupled and removed from the AACMM 100 quickly and easily without requiring additional tools. However, it is to be understood that the LLP 500 of embodiments of the present invention may utilize other types of electrical and/or mechanical interfaces to attach the LLP 500 to the AACMM 100. Further, the LLP 500 may be permanently attached to the AACMM 100 or to other devices, instead of being removably attached through use of the interface 426.

Adjacent the interface 426, the enclosure 502 includes a portion 506 that includes the projector 510 and a camera 508. The camera 508 may include a charge-coupled device (CCD) type sensor or a complementary metal-oxide-semiconductor (CMOS) type sensor for example. In the exemplary embodiment, the projector 510 and camera 508 are arranged at an angle such that the camera 508 may detect reflected light from the projector 510 onto an object. In one embodiment, the projector 510 and the camera 508 are offset from the probe tip 118 such that the LLP 500 may be operated without interference from the probe tip 118. In other words, the LLP 500 may be operated with the probe tip 118 in place. Further, it should be appreciated that the LLP 500 is substantially fixed relative to the probe tip 118 and so that forces on the handle portion 504 do not influence the alignment of the LLP 500 relative to the probe tip 118. In one embodiment, the LLP 500 may have an additional actuator (not shown) that allows the operator to switch between acquiring data from the LLP 500 and the probe tip 118.

The projector 510 and camera 508 are electrically coupled to a controller 512 disposed within the enclosure 502. The controller 512 may include one or more microprocessors, digital signal processors, memory and signal conditioning circuits. Due to the digital signal processing and large data volume generated by the LLP 500, the controller 512 may be arranged within the handle portion 504. The controller 512 is electrically coupled to the arm buses 218 via electrical connector 434. The LLP 500 further includes actuators 514, 516 which may be manually activated by the operator to initiate operation and data capture by the LLP 500.

FIG. 12 is a schematic diagram of an embodiment of the projector 510 of FIG. 11 which is used to project a substantially straight line of substantially uniform intensity onto an object to be measured. The projector 510 shown in FIG. 12 includes a light source 1210, a lens 1220, and a continuously varying neutral density filter 1240. The light source 1210 may comprise a laser, a light emitting diode (LED), a superluminescent diode (SLED), a Xenon bulb, or some other suitable type of light source. The lens 1220 depicted in FIG. 12 is used to focus the light received from the laser light source 1210 into a line of light and may comprise one or more cylindrical lenses, or lenses of a variety of other shapes. The lens is also referred to herein as a “lens system” because it may include one or more individual lenses or a collection of lenses. The line of light is substantially straight, i.e., the maximum deviation from a line will be less than about 1% of its length. One type of lens that may be utilized by an embodiment is a rod lens. Rod lenses are typically in the shape of a full cylinder made of glass or plastic polished on the circumference and ground on both ends. Such lenses convert collimated light passing through the diameter of the rod into a line. Another type of lens that may be used is a cylindrical lens. A cylindrical lens is a lens that has the shape of a partial cylinder. For example, one surface of a cylindrical lens may be flat, while the opposing surface is cylindrical in form. As described previously, the lens 1220 may produce a non-uniform line, for example a line having a hot-spot near the center of the line's length and reduced intensity near the end points of the line (e.g., exhibiting a Gaussian profile). The lens 1220 may comprise a crown glass (such as BK7), clear plastic, or other material that diffracts light.

The line produced by the lens 1220, which has an uneven intensity distribution 1230 along the length of the line, is then passed through the continuously varying neutral density filter 1240 to produce a line with a substantially even intensity distribution 1250 along the length of the line. In an embodiment, the continuously varying neutral density filter 1240 is characterized by an attenuation (also called an “optical density”) that varies over the surface of the filter. The continuously varying neutral density filter may even out intensity across a length of a line. In one embodiment, the continuously varying neutral density filter 1240 is an Apodizing Filter Bullseye manufactured by Edmund Optics Inc. for example. The line produced by the continuously varying neutral density filter 1240, with the substantially even intensity distribution 1250 is then projected onto an object to be measured by the LLP.

As used herein the term “intensity” refers to the measure of the optical power per unit area of light traveling in a given direction. In an embodiment, the intensity distribution 1230 of the line emitted from the lens 1220 has an intensity range, relative to the maximum level, of about 50% at the ends to 100% in the middle, while the intensity distribution 1250 of the line emitted from the continuously varying neutral density filter 1240 results in an intensity distribution that is substantially constant over the length of the line, for example, the line may have an intensity range that varies about +/−2% along the length of the entire line. In another embodiment, the intensity distribution 1230 of the line emitted from the lens 1220 has an intensity range of about 20% at the ends to 100% in the middle, while the intensity distribution 1250 of the line emitted from the continuously varying neutral density filter 1240 has an intensity range that varies about +/−2% along the length of the entire line. The previous intensity ranges are examples of possible intensity ranges and are not intended to be limiting as any intensity range generated by the light source 1210 is supported by embodiments of the present invention.

For the embodiments discussed herein, characteristics of the camera are known, such as the distance from the camera lens system to the photosensitive array, the focal length of the lens system, and pixel size and spacing of the photosensitive array for example. In some cases, it may be desirable to know and correct the aberrations of the lens system, such as distortion. Numerical values to provide such aberration correction may be obtained by carrying out experiments using the camera for example. In one type of experiment, for example, the camera may be used to measure the positions of dots located at known positions on a plate.

For the embodiments discussed herein, it is also desirable to know the relative spacings and orientations of projector elements for example. For example, the distance from the projector to the camera and the angle of tilt of each relative to the axis that connects the projector and camera are known. The geometry of the projected pattern relative to the mechanical projector assembly is also known.

The LLP line scanner described in the present application sends a line of laser light onto an object, which is scattered off the object, and passes the scattered light into a camera lens that directs the light onto a two-dimensional (2D) photosensitive array. The photosensitive array might be a charge coupled device (CCD) array or a complementary metal oxide semiconductor (CMOS) array, for example. The principle by which a line scanner determines the 3D coordinates of surface points is fundamentally different than the principle by which a structured light scanner determines the 3D coordinates of an object surface. As is explained in more detail below, a line scanner uses a first dimension of a photosensitive array to determine the position of the light along the direction of the stripe (line) and a second dimension of the photosensitive array to determine the distance to the object surface. By this means, 3D coordinates of the object surface may be obtained. In contrast, a structured light scanner must use both dimensions of a photosensitive array to determine the pattern of light scattered by the object surface. Consequently, in a structured light scanner, an additional means is needed to determine the distance to the object. In many structured light scanners, the distance is obtained by collecting multiple consecutive frames of camera information with the pattern changed in each frame. For example, in some structured light scanners, the pattern is changed by varying the phase and pitch of fringes in the pattern. Since multiple exposures are necessary with such a method, it is not usually possible with this method to accurately capture the 3D coordinates of a rapidly moving object. In other structured light scanners, a coded pattern is projected onto the object surface. By analysis of the overall pattern of light at the camera, detailed features of the object can be deduced. This method permits measurements to be made of moving objects, but accuracy is not usually as good as with a structured light scanner that collects several frames of camera information to determine the 3D coordinates of a stationary object.

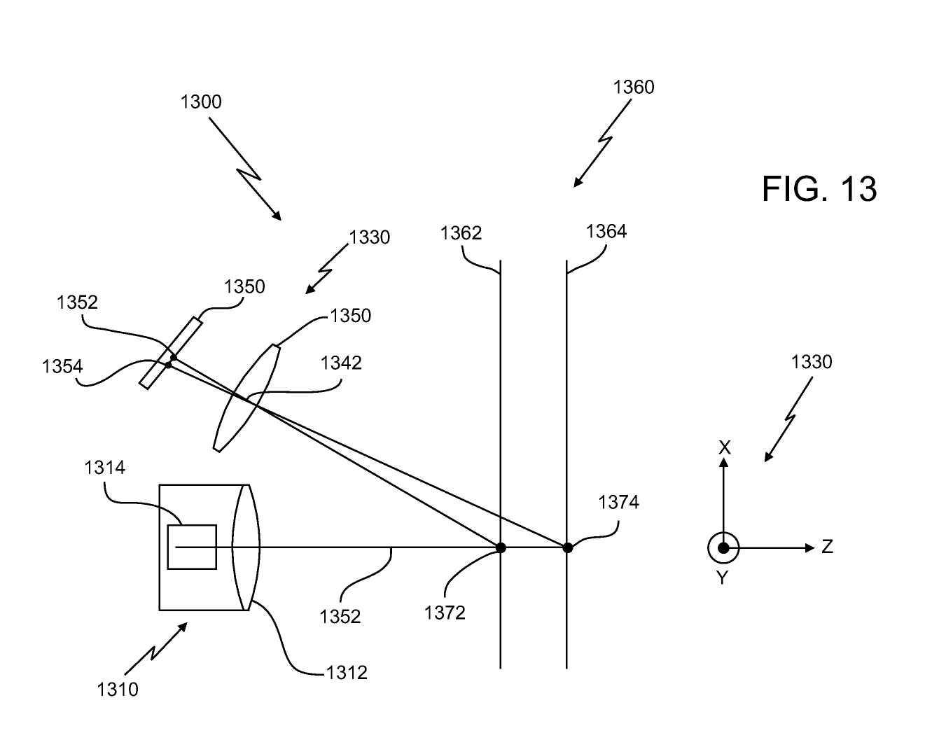

The principle of operation of a line scanner, such as the LLP, is shown schematically in FIG. 13. A top view of a line scanner 1300 includes a projector 1310 and a camera 1330, the camera including a lens system 1340 and a photosensitive array 1350 and the projector including an objective lens system 1312 and a pattern generator 1314 (e.g., a laser light source). The projector 1310 projects a line 1352 (shown in the figure as projecting out of the plane of the paper) onto the surface of an object 1360, which may be placed at a first position 1362 or a second position 1364. Light scattered from the object at the first point 1372 travels through a perspective center 1342 of the lens system 1340 to arrive at the photosensitive array 1350 at position 1352. Light scattered from the object at the second position 1374 travels through the perspective center 1342 to arrive at position 1354. By knowing the relative positions and orientations of the projector 1310, the camera lens system 1340, the photosensitive array 1350, and the position 1352 on the photosensitive array, it is possible to calculate the 3D coordinates of the point 1372 on the object surface. Similarly, knowledge of the relative position of the point 1354 rather than 1352 will yield the 3D coordinates of the point 1374. The photosensitive array 1350 may be tilted at an angle to satisfy the Scheimpflug principle, thereby helping to keep the line of light on the object surface in focus on the array.

One of the calculations described herein above yields information about the distance of the object from the line scanner—in other words, the distance in the z direction, as indicated by the coordinate system 1380 of FIG. 13. The information about the x position and y position of each point 1372 or 1374 relative to the line scanner is obtained by the other dimension of the photosensitive array 1350, in other words, the y dimension of the photosensitive array. Since the plane that defines the line of light as it propagates from the projector 1310 to the object is known from the coordinate measuring capability of the articulated arm, it follows that the x position of the point 1372 or 1374 on the object surface is also known. Hence all three coordinates—x, y, and z—of a point on the object surface can be found from the pattern of light on the 2D array 1350.

Embodiments of the LLP 500 have been described herein as being included within an accessory device or as an attachment to a portable AACMM 100. However, this is for exemplary purposes and the claimed invention should not be so limited. Other embodiments of the LLP 500 are contemplated by the present invention, in light of the teachings herein. For example, the LLP may be utilized in a fixed or non-articulated arm (i.e., non-moving) CMM. Other fixed inspection installations are contemplated as well. For example, a number of such LLPs 500 may be strategically placed in fixed locations for inspection or measurement purposes along some type of assembly or production line; for example, for automobiles.

While the invention has been described with reference to example embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A laser line probe (LLP) configured to measure an object, the LLP comprising:
a projector that includes a light source, a first lens system, and a continuously varying neutral density filter, the light source configured to emit light, the first lens system configured to receive the light and to spread out the light into a first line of light having a first intensity distribution across the first line of light, the continuously varying neutral density filter configured to convert the first line of light into a second line of light having a substantially uniform intensity distribution across the second line of light and to project the second line of light onto the object;
a camera that includes a second lens system and a photosensitive array, the camera having predetermined characteristics including a focal length of the second lens system and a position of the photosensitive array relative to the second lens system, and wherein the second lens system is configured to collect the light reflected by or scattered off the object as a first collected light and image the first collected light onto the photosensitive array, the photosensitive array configured to convert the first collected light into an electrical signal;
a bracket to which are attached in a substantially fixed and predetermined geometrical configuration the projector and the camera; and
an electronic circuit including a processor, wherein the electronic circuit is configured to determine three-dimensional (3D) coordinates of a plurality of points of light projected on the object by the projector, the 3D coordinates based at least in part on the electrical signal, the camera characteristics, and the geometrical configuration.

2. The LLP of claim 1, wherein the first intensity distribution exhibits a Gaussian profile.

3. The LLP of claim 1, wherein the first line of light has a midpoint and two ends and the first intensity distribution across the first line of light includes a higher intensity at the midpoint than at the two ends.

4. The LLP of claim 1, wherein the continuously varying neutral density filter comprises an apodizing filter.

5. The LLP of claim 1, wherein the first lens system comprises a rod lens.

6. The LLP of claim 1, wherein the light source is a laser light source.

7. The LLP of claim 1, wherein the LLP is configured to be attached to a portable articulated arm coordinate measuring machine.

8. The LLP of claim 1, wherein the LLP is configured to be attached at a fixed location.

9. The LLP of claim 1, wherein the LLP is configured to be portable and handheld.

10. A portable articulated arm coordinate measuring machine (AACMM) for measuring the coordinates of an object in space, the portable AACMM comprising:
a manually positionable articulated arm having opposed first and second ends, the arm portion including a plurality of connected arm segments, each arm segment including at least one position transducer for producing a position signal;
a base section connected to the second end; and
a probe assembly connected to the first end, the probe assembly including a laser line probe (LLP) configured to scan the object in space, the LLP including:
a projector configured to project light on the object in a line, the projector including a first lens system and a continuously varying neutral density filter, the continuously varying neutral density filter configured to receive light from the first lens system and project it onto the object, the continuously varying neutral density filter further configured to project light having an intensity that is substantially uniform along the length of the line;
a camera that includes a second lens system and a photosensitive array, the camera having predetermined characteristics including a focal length of the second lens system and a position of the photosensitive array relative to the second lens system, and wherein the second lens system is configured to collect the light reflected by or scattered off the object as a first collected light and image the first collected light onto the photosensitive array, the photosensitive array configured to convert the first collected light into an electrical signal;
a bracket to which are attached in a substantially fixed and predetermined geometrical configuration the projector and the camera; and
an electronic circuit including a processor, wherein the electronic circuit is configured to determine three-dimensional (3D) coordinates of a plurality of points of light projected on the object by the projector, the 3D coordinates based at least in part on the electrical signal, the camera characteristics, and the geometrical configuration.

11. The AACMM of claim 10, wherein the first lens system comprises a rod lens.

12. The AACMM of claim 10, wherein the continuously varying neutral density filter comprises an apodizing filter.

13. A method of operating a laser line probe (LLP) for measuring an object in space, the method comprising:
emitting a light from a light source;
receiving the light at a first lens system;
spreading out the light, by the first lens system, into a first line of light having a first intensity distribution across the first line of light;
converting the first line of light, by a continuously varying neutral density filter, into a second line of light having a substantially uniform intensity distribution across the second line of light;
projecting the second line of light onto the object;
collecting, by a camera, the light reflected by or scattered off the object as a first collected light onto a photosensitive array, the camera including a second lens system and the photosensitive array, the camera having predetermined characteristics including a focal length of the second lens system and a position of the photosensitive array relative to the second lens system, the light source, the first lens system, the filter and the camera attached to a bracket in a substantially fixed and predetermined geometrical configuration;
converting, by the photosensitive array, the first collected light into an electrical signal;
calculating, by a processor, three-dimensional coordinates of a plurality of points of light projected on the object, the calculating based at least in part on the electrical signal, the camera characteristics and the geometrical configuration; and
storing the three-dimensional coordinates of the plurality of points of light.

14. The method of claim 13, wherein the first intensity distribution exhibits a Gaussian profile.

15. The method of claim 13, wherein the first line of light has a midpoint and two ends and the first intensity distribution across the first line of light includes a higher intensity at the midpoint than at the two ends.

16. The method of claim 13, wherein the continuously varying neutral density filter comprises an apodizing filter.

17. The method of claim 13, wherein the light source is a laser light source.

18. The method of claim 13, wherein the first lens system comprises a rod lens.

19. The method of claim 13, wherein the LLP is configured to be attached to a portable articulated arm coordinate measuring machine.

20. The method of claim 13, wherein the LLP is configured to be attached at a fixed location.

21. The method of claim 13, wherein the LLP is configured to be portable and handheld.
